(19) United States
(12) Patent Application Publication
(10) Pub. No.: US 2011/0221803 A1
(43) Pub. Date: Sep. 15, 2011

(54) INK SUPPLY APPARATUS

(75) Inventors: Akihiko KOBAYASHI, Tomi-shi (JP); Kazumi Sakurai, Tomi-shi (JP)

(73) Assignee: MIMAKI ENGINEERING CO., LTD., Tomi-shi (JP)

(21) Appl. No.: 13/075,191

(22) Filed: Mar. 30, 2011

Related U.S. Application Data
(63) Continuation of application No. PCT/JP2009/050254, filed on Jan. 9, 2009.

(51) Int. Cl. B41J 2/175; B41J 29/38

(52) U.S. Cl. 347/7; 347/6

(57) ABSTRACT

An ink supply apparatus includes a sub tank connected to a printer head and having an ink reservoir chamber to store a liquid ink. A fluid level detector is configured to detect a fluid level of the liquid ink stored in the ink reservoir chamber. The fluid level detector has a light emitting device, a light receiving device, and a casing having a section through which a light is to pass and which has an outer surface that is to contact the liquid ink. The light emitting device is capable of emitting the light toward the outer surface through the section. The light receiving device is to receive reflected light reflected at the outer surface. A storage amount determining device is configured to determine whether a predetermined amount of the liquid ink is stored in the ink reservoir chamber based on detection results of the fluid level detector.

### CROSS-REFERENCE TO RELATED APPLICATIONS

The present application is a continuation application of International Application No. PCT/JP2009/050254, filed Jan. 9, 2009. The contents of this application are incorporated herein by reference in their entirety.

### BACKGROUND OF THE INVENTION

1.Field of the Invention

The present invention relates to an ink supply apparatus.

2. Discussion of the Background

In printer devices (inkjet printers), printing is typically performed by adhering an ink to a printing medium, which is mounted on a platen, in a predetermined pattern by discharging the ink from discharge nozzles provided on a lower surface of a printer head while causing the printer head to move relative to the printing medium. In this printer device, if an internal pressure of the printer head becomes higher than atmospheric pressure, the ink is extruded from the discharge nozzles and dribbles onto the printing medium causing a so called dripping problem.

As a method for solving this problem, providing a sub-tank that includes an ink chamber of a small capacity between a main tank, such as an ink cartridge, and the printer head and setting an internal pressure of the printer head to a marginally negative pressure by reducing a pressure within the ink chamber in the sub-tank is known in the art. For example, in FIG. 1 of Japanese Unexamined Patent Application Laid-open No. 2006-62330, an ink 12 stored in a main tank 14 is supplied to and temporarily stored in a sub-tank 13 due to a hydraulic head difference and the ink is supplied to a discharge head 11 from the sub-tank 13 when an ink is discharge from the discharge head 11. An internal pressure of the sub-tank 13 is maintained to a marginally negative pressure using a negative pressure generating unit 19.

In a method different from the method of supplying the ink to the sub-tank that uses the hydraulic head difference disclosed in Japanese Unexamined Patent Application Laid-open No. 2006-62330 described above, a supply pump is arranged in an ink supply path that connects a main tank and a sub-tank and the ink is supplied from the main tank to the sub-tank depending on an amount of ink in the sub-tank by causing the supply pump to drive. Though it is an advantage of this configuration that the main tank 14 can be arranged at any position, there is also a disadvantage in that a detecting unit is required to detect the amount of ink (a height of the ink fluid level) in the sub-tank to control the driving of the supply pump. Note that the reference numerals correspond to reference numerals used in Japanese Unexamined Patent Application Laid-open No. 2006-62330. In view of this fact, for example, in Japanese Unexamined Patent Application Laid-open No. 2001-141547, a method is disclosed in which the height of the fluid level of fluid collected in any container, and not limited to the sub-tank, is detected using a magnetic force of a magnet 6 attached to a float 4. Note that the reference numerals correspond to reference numerals used in Japanese Unexamined Patent Application Laid-open No. 2001-141547.

### SUMMARY OF THE INVENTION

According to one aspect of the present invention, an ink supply apparatus includes a sub tank, a fluid level detector, an ink supply path, an internal pressure regulating path, and a storage amount determining device. The sub tank is connected to a printer head and has an ink reservoir chamber formed in the sub tank to store a liquid ink. The printer head is capable of discharging the liquid ink which is supplied from the ink supply apparatus. The fluid level detector is provided inside the ink reservoir chamber. The fluid level detector is configured to detect a fluid level of the liquid ink stored in the ink reservoir chamber. The fluid level detector includes a casing, a light emitting device, and a light receiving device. The casing has a section through which a light is to pass. The section has an outer surface that is to contact the liquid ink according to an amount of the liquid ink stored in the ink reservoir chamber. The light emitting device is arranged inside the casing and is capable of emitting the light toward the outer surface through the section. The light receiving device is to receive reflected light reflected at the outer surface when the outer surface does not contact the liquid ink and reflects the light emitted from the light emitting device. The ink supply path connects a main tank and the ink reservoir chamber to supply the liquid ink from the main tank to the ink reservoir chamber. The internal pressure regulating path connect the ink reservoir chamber and a pressure regulating device capable of sucking air from or discharging air to the ink reservoir chamber so as to regulate an internal pressure of the ink reservoir chamber. The storage amount determining device is configured to determine whether a predetermined amount of the liquid ink is stored in the ink reservoir chamber based on detection results of the fluid level detector.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a front view of a printer device to which the embodiment of the present invention is applied;

FIG. 2 is a perspective view that shows a portion near a head unit of the printer device shown in FIG. 1;

FIG. 3 is a schematic diagram of an ink supply circuit of the printer device shown in FIG. 1;

FIG. 4 is a perspective view of a sub-tank;

FIGS. 5A, 5B, and 5C are, respectively, a front view, a side view, and a bottom view of a fluid level detecting unit; and

FIGS. 6A and 6B are illustrative diagrams of operations of the fluid level detecting unit showing a state in FIG. 6A in which the ink is not filled in a surrounding of the fluid level detecting unit and a state in FIG. 6B in which the ink is filled in the surrounding of the fluid level detecting unit.

### DESCRIPTION OF THE EMBODIMENTS

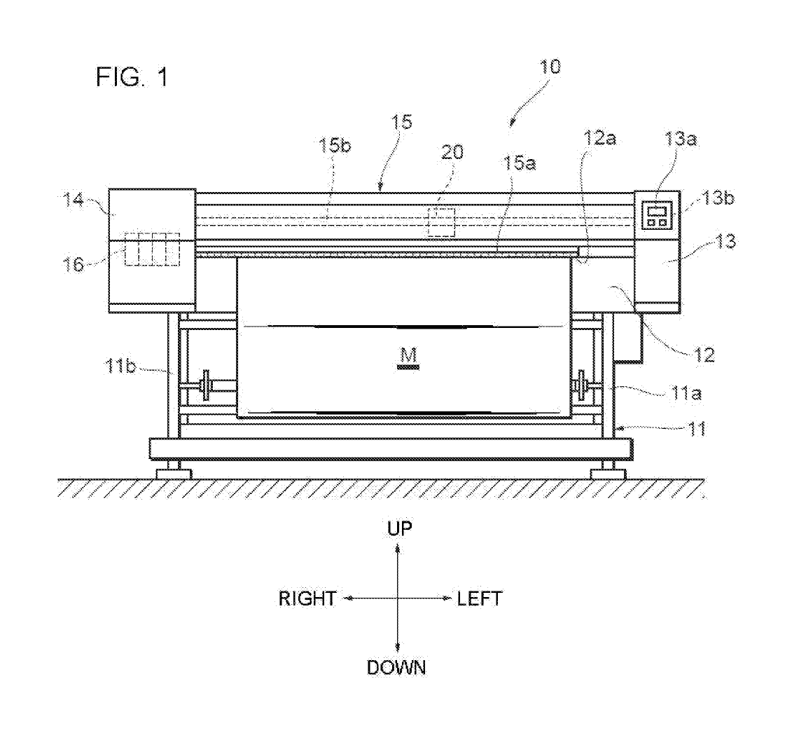

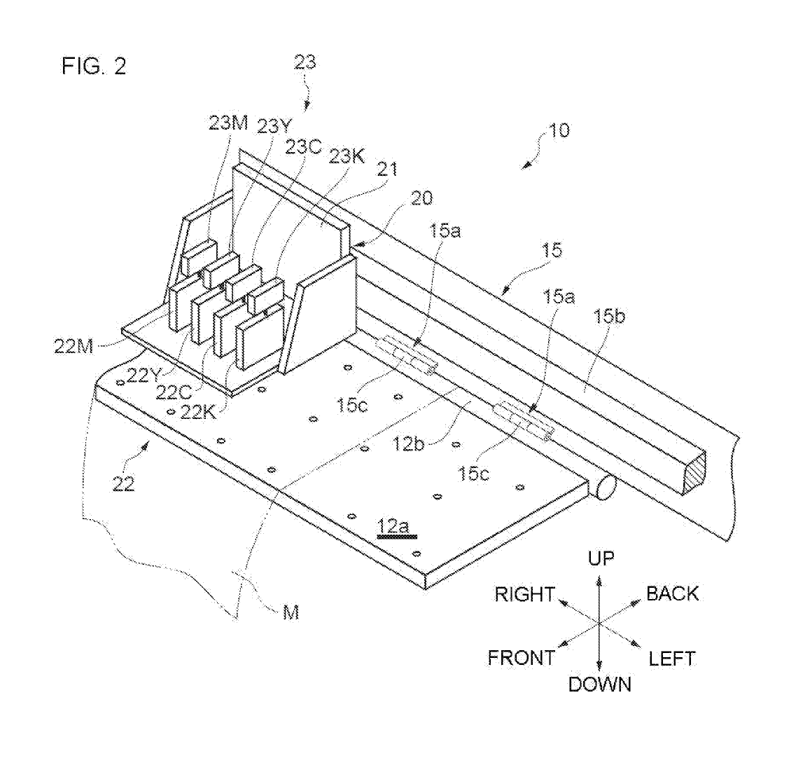

The embodiments of the present invention are explained below with reference to the accompanying drawings, wherein like reference numerals designate corresponding or identical elements throughout the various drawings. For the sake of simplicity, an explanation will be given with the help of arrow directions that are shown in the drawings and are defined as front-back, left-right, and up-down. An overall configuration of a printer device 10 that is an example of an inkjet printer to which the embodiment of the present invention is applied, is explained with reference to FIGS. 1 and 2. FIG. 1 is a front view of the printer device 10 and FIG. 2 is a perspective view showing a portion near a head unit 20 that is described later.

As shown in FIG. 1, the printer device 10 includes a supporting frame 11 that consists of a left supporting leg 11a and a right supporting leg 11b, a central body 12 that is supported by the supporting frame 11, a left body 13 arranged on the left side of the central body 12, a right body 14 arranged on the right side of the central body 12, and an upper body 15 that is arranged above and parallel to the central body 12 with a gap therebetween, and extends across connecting the left body 13 and the right body 14. A platen 12a that extends across horizontally is provided in the central body 12 and is exposed to an upper surface thereof.

As shown in FIG. 2, a plurality of clamping units 15a is fixed to a lower portion of the upper body 15 and arranged in a horizontal direction. A pinch roller 15c is rotatably fixed to a front end portion of each of the clamping units 15a. A feed roller 12b that extends across horizontally and has a cylindrical shape is in contact with the platen 12a, and arranged beneath the pinch rollers 15c. The clamping units 15a can be set in a clamping position at which the pinch rollers 15c are in pressure contact with the feed roller 12b, and in an unclamping position at which the pinch rollers 15c are separated from the feed roller 12b. By this configuration, a printing sheet M that is a printing target, after being sandwiched between the pinch rollers 15c and the feed roller 12b with the clamping units 15a set in the clamping position, can be moved forward or backward by a predetermined distance by causing the feed roller 12b to rotate.

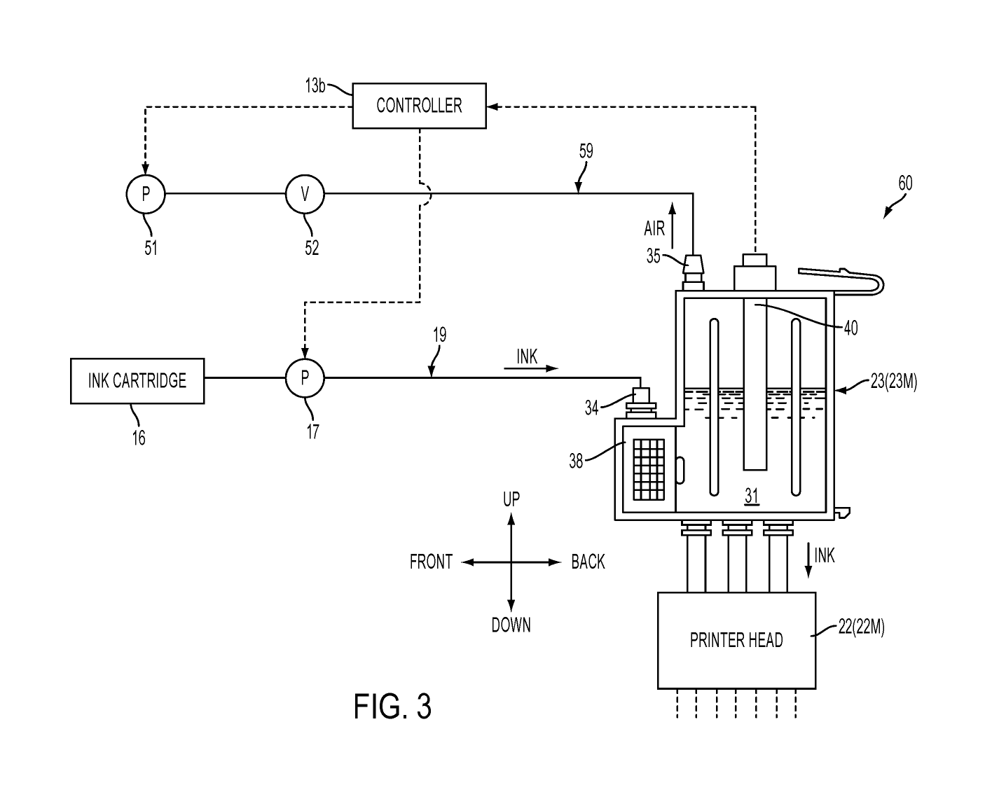

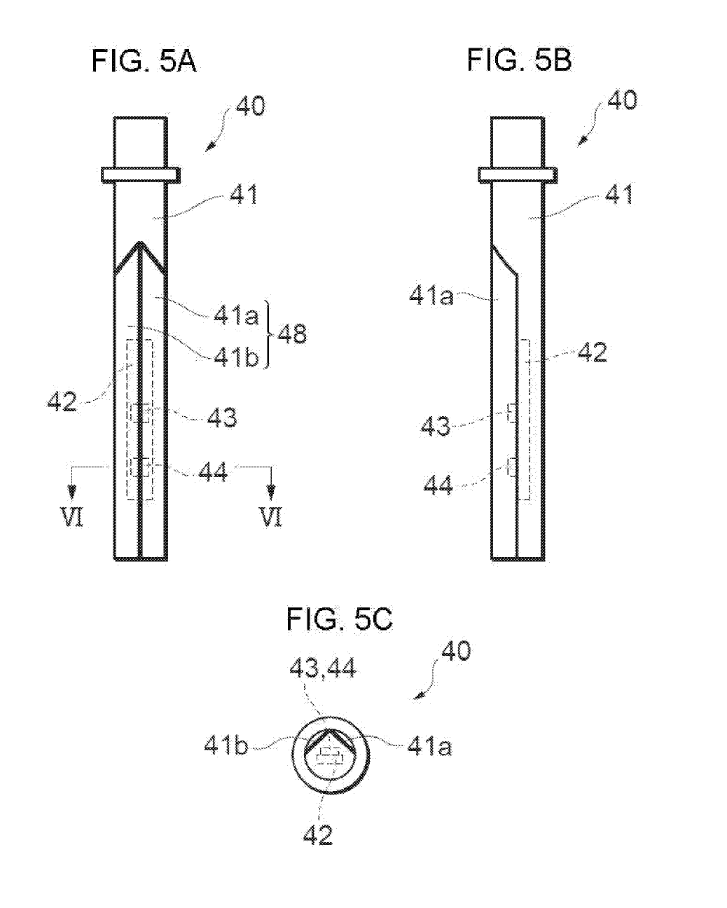

As shown in FIG. 1, an operating unit 13a that includes operating switches, display panels, etc., is provided on a front surface of the left body 13. Moreover, a controller 13b is provided inside the left body 13. The controller 13b outputs operation signals to structural components such as a fluid feed pump 17 and a suction pump 51 (see FIG. 3) of the printer device 10 that are described later and performs operation control. Moreover, the controller 13b receives detection signals from an upper fluid level detecting sensor 43 and a lower fluid level detecting sensor 44 that are described later (see FIGS. 5A to 5C). An ink cartridge 16 that stores therein a predetermined amount of ink is attached to a back surface of the right body 14 so as to be attachable and detachable from behind. In FIG. 1, a configuration is illustrated in which four ink cartridges 16, each of which storing therein an aqueous ink of magenta (M), yellow (Y), cyan (C), and black (K) color, are mounted.

As shown in FIG. 2, a guide rail 15b that extends across horizontally is arranged inside the upper body 15 and the head unit 20 is fixed such that it can reciprocate horizontally along the guide rail 15b. The head unit 20 primarily includes a carriage 21, a printer head 22, and a sub-tank 23. A back surface of the carriage 21 is fitted to the guide rail 15b; therefore, the carriage 21 can reciprocate horizontally along the guide rail 15b. Furthermore, the carriage 21 serves as a base for mounting the printer head 22 and the sub-tank 23.

The printer head 22 includes, for example, printer heads 22M, 22Y, 22C, and 22K of magenta, yellow, cyan, and black color, respectively. A plurality of discharge nozzles (not shown) are provided, respectively, on bottom surfaces of the printer heads 22M, 22Y, 22C, and 22K for discharging the ink in a downward direction. The sub-tank 23 includes sub-tanks 23M, 23Y, 23C, and 23K that correspond to the four colors mentioned above. Each of the sub-tanks 23M, 23Y, 23C, and 23K stores therein a predetermined amount of ink. Detailed structure is described later. Each of the sub-tanks 23M, 23Y, 23C, and 23K is arranged above the corresponding printer heads 22M, 22Y, 22C, and 22K and is connected to the corresponding printer heads 22M, 22Y, 22C, and 22K such that the ink stored therein can be supplied to the corresponding printer heads 22M, 22Y, 22C, and 22K.

A configuration of the sub-tank 23 is explained in detail below with reference to FIGS. 3 to 6B.

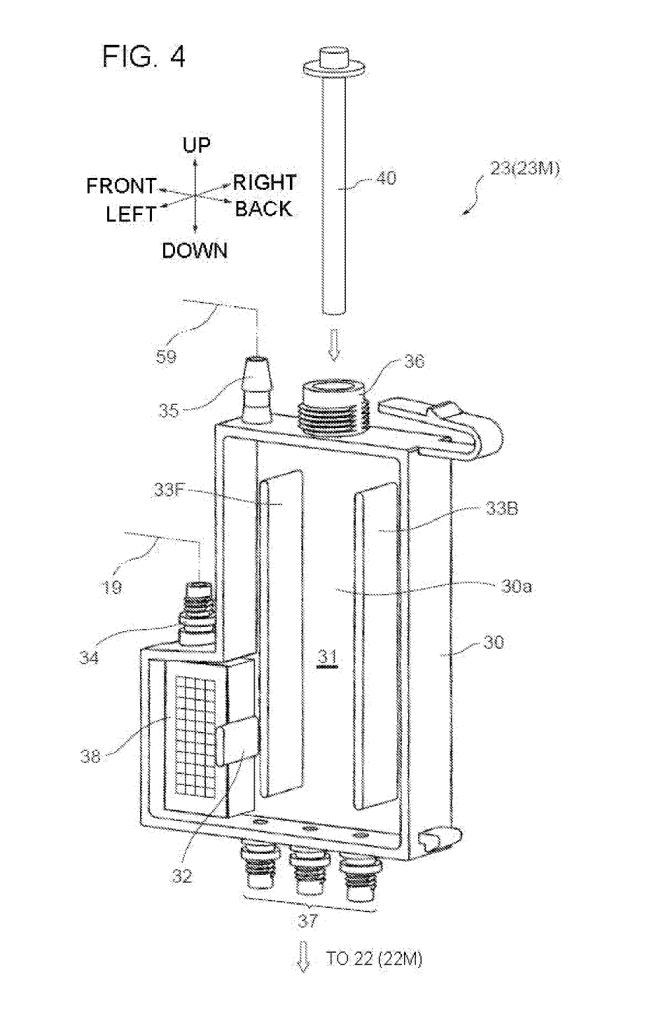

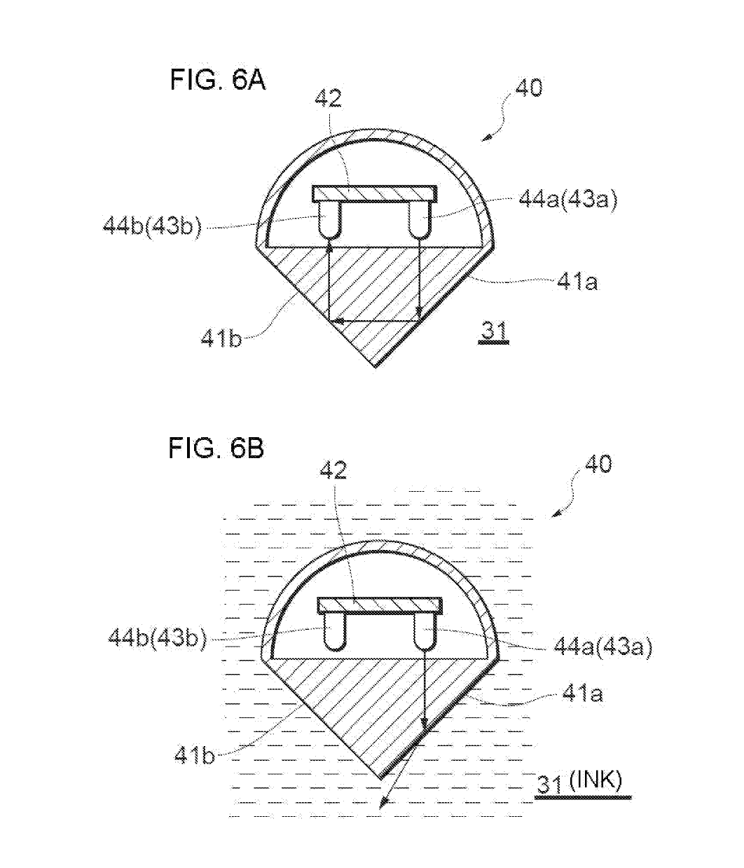

FIG. 3 is a schematic diagram of an ink supply circuit 60 that is described later. FIG. 4 is a perspective view of the sub-tank 23. FIGS. 5A to 5C are schematic diagrams of a fluid level detecting unit 40 that is described later, and FIGS. 6A and 6B are illustrative diagrams of an operation of the fluid level detecting unit 40. FIGS. 3 and 4 illustrate the ink supply circuit 60 of magenta color that includes the printer head 22M and the sub-tank 23M corresponding to the printer head 22M. The ink supply circuit 60 of magenta color is explained below as an example. The configuration of ink supply circuit 60 holds true for the other colors.

As shown in FIG. 3, the ink supply circuit 60 mainly includes an ink supply path 19, a decompression path 59, and the sub-tank 23M. The ink is supplied from the sub-tank 23M to the printer head 22M due to the hydraulic head difference.

An end of the ink supply path 19 is connected to an ink supply port 34 of the sub-tank 23M and the ink cartridge 16 and the fluid feed pump 17 are arranged in the ink supply path 19. The fluid feed pump 17 is a pump that sucks the ink from the ink cartridge 16 and pressure-feeds it into the sub-tank 23M, and can, for example, be a tube pump or a diaphragm pump. Thus, by driving the fluid feed pump 17, the ink in the ink cartridge 16 can be supplied from the ink supply port 34 to inside of the sub-tank 23M.

An end of the decompression path 59 is connected to a suction port 35 of the sub-tank 23M. A suction pump 51 and a flow regulating valve 52 are arranged in the decompression path 59. An air suction port (not shown) of the suction pump 51 is connected to the decompression path 59; therefore, the flow regulating valve 52 can regulate an amount of air that passes through the decompression path 59. Thus, by driving the suction pump 51 during printing, an internal pressure of the sub-tank 23M can be set to a predetermined negative pressure that is suitable for formation of a meniscus in the discharge nozzles by sucking the air from inside of the sub-tank 23 according to an amount of air regulated with the flow regulating valve 52.

As shown in FIG. 4, the sub-tank 23M mainly includes a tank body 30 with an ink reservoir chamber 31 formed therein, a filter 38 fixed to the ink reservoir chamber 31, and the fluid level detecting unit 40 inserted in the ink reservoir chamber 31. A transparent film (not shown) is adhered so as to cover an entire left side face of the sub-tank 23M. The tank body 30 is formed in a substantially rectangular parallelepiped shape using a resin material. The tank body 30 is left open towards left and a depressed portion is treated as the ink reservoir chamber 31. The predetermined amount of ink is stored in the ink reservoir chamber 31 during printing.

In the tank body 30, a supporting rib 32 is arranged vertically towards left from a right bottom 30a and wave preventing ribs 33F and 33B that extend vertically are formed. The film is adhered not only to a left end face of the tank body 30 but also to a left end face of the supporting rib 32 and the wave preventing ribs 33F and 33B. Due to this, excessive bending of the film can be prevented from occurring when the internal pressure of the sub-tank 23M changes.

A lower portion of the tank body 30 protrudes towards the front side and the ink supply port 34 is fitted on an upper surface of this protruding portion. The filter 38 that is formed in a substantially rectangular parallelepiped shape is inserted into the protruding portion of the tank body 30. The filter 38 is supported by the supporting rib 32 such that it does not move towards left and right sides. With this configuration, the ink supplied from the ink supply port 34 is led inside the filter 38. The ink is filtered while flowing from the left side face of the filter 38 and proceeds towards the ink reservoir chamber 31. Due to this, fine dirt, etc., is removed from the ink, and a dirt-free ink can be stored in the ink reservoir chamber 31, and supplied to the printer head 22M enabling a stable ink discharge without any discharge failure, etc., at the discharge nozzles.

Furthermore, the suction port 35 is provided on the front side of an upper surface of the tank body 30 and an installation opening 36 is provided at the center of the upper surface of the tank body 30. The fluid level detecting unit 40 is inserted into the installation opening 36. Furthermore, three ink discharge ports 37 that communicate with the ink reservoir chamber 31 are provided to the bottom of the tank body 30 and the ink is supplied to the printer head 22M from the ink discharge ports 37.

As shown in FIGS. 5A to 5C, the fluid level detecting unit 40 mainly includes a casing 41 made from, for example, a transparent or a semi-transparent fluorine resin in a substantially cylindrical shape, a substrate 42 that is arranged inside the casing 41, and the upper fluid level detecting sensor 43 and the lower fluid level detecting sensor 44, respectively, attached to predetermined upper and lower positions relative to the substrate 42. A prism 48 that includes a first reflective surface 41a and a second reflective surface 41b on an outer surface, and that has a substantially isosceles triangle shape in a cross-sectional view is formed at the bottom end from near the center of the casing 41. As shown in FIGS. 6A and 6B, the lower fluid level detecting sensor 44 includes a light emitting element 44a and a light receiving element 44b that are mounted on the substrate 42 in a line. The upper fluid level detecting sensor 43 also has a similar configuration, and includes a light emitting element 43a and a light receiving element 43b. Because a light emitted from the light emitting element 43a (44a) is reflected by the first reflective surface 41a and the second reflective surface 41b and is received by the light receiving element 43b (44b), the structure of the upper fluid level detecting sensor 43 and the lower fluid level detecting sensor 44 can be made compact.

The configuration of the printer device 10 is explained hitherto. An operation of each component when performing printing on the printing sheet M using the printer device 10 is explained below.

The printing sheet M that is wound in a roll is dispatched during printing and fed onto the platen 12a as shown in FIG. 2. The ink is discharged in a downward direction from the discharge nozzles provided on the bottom surface of the printer head 22 while the carriage 21 is reciprocating horizontally along the guide rail 15b relative to the printing sheet M placed on the platen 12a and printing is performed by adhering the ink in a predetermined pattern. After the printing sheet M is moved forward by a predetermined distance by causing the feed roller 12b to rotate, the ink is adhered to the printing sheet M while causing the carriage 21 to reciprocate again horizontally. The printing sheet M on which the printing is performed is wound in a roll on a front side of the printer device 10 by repeatedly performing the above operation.

When the printing is performed in this manner, the ink is discharged from the printer head 22 and the ink equivalent to the discharged ink amount is automatically supplied from the sub-tank 23 to the printer head 22 due to the hydraulic head difference. Thus, when it is detected that an amount of ink in the sub-tank 23 has gradually reduced and reached a predetermined minimum amount, the ink is supplied from the ink cartridge 16 to the sub-tank 23. Detection of the amount of ink in the sub-tank 23 and control of ink supply to the sub-tank 23 are explained below.

A state in which the fluid level of the ink stored in the ink reservoir chamber 31 is positioned between, for example, the upper fluid level detecting sensor 43 and the lower fluid level detecting sensor 44 is explained first. In this case, because the ink has not reached a level corresponding to a height of the upper fluid level detecting sensor 43, as shown in FIG. 6A, the light emitted from the light emitting element 43a of the upper fluid level detecting sensor 43 is entirely reflected by the first reflective surface 41a and the second reflective surface 41b based on a refractive index difference between the prism 48 and the air and this light is received by the light receiving element 43b. On the other hand, as shown in FIG. 6B, because the surrounding of the lower fluid level detecting sensor 44 is filled with the ink and the refractive index difference between the prism 48 and the ink has reduced, a major portion of the light emitted from the light emitting element 44a of the lower fluid level detecting sensor 44 progresses in a direction where the ink exists (outward direction of the casing 41) without being entirely reflected by the first prism surface 41a towards the second prism surface 41b, and is not received by the light receiving element 44b. When light reception results of the light receiving elements 43b and 44b are output to the controller 13b, the controller 13b detects that the ink fluid level is positioned between the upper fluid level detecting sensor 43 and the lower fluid level detecting sensor 44 and determines that the predetermined amount of ink is present in the ink reservoir chamber 31. Therefore, the fluid feed pump 17 is not driven and it is kept in a halted state.

A case is now explained in which the fluid level of the ink being supplied to the printer head 22 has gradually dropped to a position of the lower fluid level detecting sensor 44. In this case, along with the upper fluid level detecting sensor 43 and the lower fluid level detecting sensor 44, the light is also detected by the light receiving elements 43b and 44b as shown in FIG. 6A. From these detection results, the controller 13b detects that the ink fluid level has dropped to the position of the lower fluid level detecting sensor 44 and determines that the ink fluid level has reached the minimum amount. Therefore, the controller 13b causes the fluid feed pump 17 to be driven and the ink is supplied from the ink cartridge 16 to the ink reservoir chamber 31.

In a short while, due to the fluid feed pump 17 being driven as described above, the ink fluid level rises to a position of the upper fluid level detecting sensor 43. When this happens, the light is detected neither by the upper fluid level detecting sensor 43 nor by the lower fluid level detecting sensor 44, and as shown in FIG. 6B, nor by the light receiving elements 43b and 44b. Therefore, the controller 13b detects that the ink is stored up to a position of the upper fluid level detecting sensor 43 and determines that the ink fluid level has reached a maximum amount, and stops driving the fluid feed pump 17.

As described above, the predetermined amount of ink can always be secured in the ink reservoir chamber 31 by controlling the driving of the fluid feed pump 17 based on the detection results of the ink fluid level in the ink reservoir chamber 31. Therefore, the printer head 22 can perform a stable ink discharge. In a configuration in which a float is made to float on an ink fluid surface, for example, when the float gets stuck at the bottom position and cannot move vertically with changes in the fluid level, not only is the fluid level detected incorrectly but an amount of ink exceeding the maximum amount may be supplied to the sub-tank 23, thus leading to a risk of damage. On the other hand, in the printer device 10 according to the embodiment of the present invention, the ink fluid level is detected using an optical fluid level detecting unit 40. Because the optical fluid level detecting unit 40 does not have movable parts, the risk of damage can be minimized and the height of the fluid level can be detected in a highly precise and reliable manner.

In the printer device 10 according to the embodiment of the present invention, the wave preventing ribs 33F and 33B are formed in the tank body 30 so as to anteroposteriorly enclose the fluid level detecting unit 40 inserted vertically. The carriage 21 reciprocates horizontally during printing and the sub-tank 23 swings horizontally; however, due to the wave preventing ribs 33F and 33B, significant waving of the ink present inside the ink reservoir chamber 31 and changes in the fluid level can be prevented from occurring. Therefore, the height of the fluid level of the ink can be detected more precisely with the fluid level detecting unit 40. Furthermore, in the printer device 10 according to the embodiment of the present invention, because the casing 41 of the fluid level detecting unit 40 is made of fluorine resin having a high water repellency, the ink does not adhere to the casing 41 (first reflective surface 41a and second reflective surface 41b) and incorrect detection of the height of the ink fluid level using the fluid level detecting unit 40 can be reduced.

The ink supply circuit 60 that supplies the ink from the ink cartridge 16 mounted on the back surface of the right body 14 to the sub-tank 23 is illustrated in the embodiment described above; however, the embodiment is not limited this configuration. For example, an ink tank that stores therein an ink or an ink pack can be used in place of the ink cartridge 16. Furthermore, the ink cartridge 16 can be mounted below or above the right body 14.

In the embodiment described above, a case in which an aqueous ink is used is explained as an example; however, various other types of inks can be used. For example, printing can be performed by mounting an ultraviolet radiation device on the carriage 21 and using an ultraviolet curing ink.

In the embodiment described above, the decompression path 59 is arranged in the ink supply circuit 60 and the air is set to a predetermined negative pressure by sucking it from inside the sub-tank 23. However, in addition to this, a pressurizing path that can be set to a predetermined positive pressure by supplying the air inside the sub-tank 23 can also be arranged. Such a configuration is effective for cleaning the ink reservoir chamber 31 of the sub-tank 23 by discharging the entire ink stored therein.

The configuration of the upper fluid level detecting sensor 43, the lower fluid level detecting sensor 44, and the prism 48 is cited as an example in the embodiment described above; however, the present embodiment is not limited to this configuration. For example, a prism that consists of only one reflective surface can be used and a light receiving element can be arranged at a position at which it can receive the light that is emitted from the light emitting element and is reflected by the reflective surface of the prism.

In the embodiment described above, the printer device 10 of a uniaxial printing medium moving type and a uniaxial printer head moving type is explained as an example of the printer device to which the embodiment of the present invention is applied. However, application of the present invention is not limited to this configuration. The present invention can be applied to, for example, a printer device of a biaxial printer head moving type or a printer device of a biaxial printing medium moving type.

An ink supply device according to the embodiment of the present invention includes a sub-tank with a fluid level detecting unit attached thereto, an ink supply path, and an internal pressure regulating path. In the fluid level detecting unit, when a light emitted from a light emitting unit is reflected by a section subjected to light projection, it is received by a light receiving unit. Thus, whether a liquid ink has reached a height of the light emitting unit and the light receiving unit, and whether the light emitted from the light emitting unit is received by the light receiving unit can be detected using an optical method. Thus, because the fluid level detecting unit does not have movable parts, a situation such as sticking of a float to the walls is not likely to occur when compared with a configuration in which the float is made to float on an ink fluid surface and a height of the fluid level is detected with a magnetic force of a magnet. As a result, the height of the ink fluid level can be precisely detected while maintaining the ink reservoir chamber to a marginally negative pressure with an internal pressure regulating path.

It is preferable that the fluid level detecting unit be configured such that when the liquid ink is not positioned in an outer surface of the section subjected to light projection, the light emitted from the light emitting unit is entirely reflected by the outer surface of the section subjected to light projection and the light is received by the light receiving unit. On the other hand, when the liquid ink is positioned in the outer surface of the section subjected to light projection, the light is transmitted towards the direction of the liquid ink without being reflected by the outer surface of the section subjected to light projection and it is seldom received by the light receiving unit. In this case, because the height of the ink fluid level can be detected by reflecting or transmitting the light emitted from the light emitting unit based on a refractive index difference, and the fluid level detecting unit does not have movable parts, the fluid level can be repeatedly detected with high precision.

It is preferable that a pressure feed unit that pressure-feeds the liquid ink be arranged in the ink supply path and a storage amount determining unit cause, upon determining that a predetermined amount of the liquid ink is not stored, the pressure feed unit to drive for supplying the liquid ink to the ink reservoir chamber. With this configuration, the predetermined amount of the liquid ink is always stored in the ink reservoir chamber by controlling the driving of the pressure feed unit with the storage amount determining unit and the stored liquid ink can be supplied to a printer head without interruption. Due to this, the liquid ink can be stably discharged from the printer head.

It is preferable that ribs be formed in the sub-tank on either side of the fluid level detecting unit attached to the sub-tank. With this configuration, the sub-tank performs traversal movement along with the printer head and swings during printing. Thus, even if the liquid ink inside the ink storage chamber waves, waving of the liquid ink (changes in the fluid level) can be restricted with these ribs. Thus, a height of the fluid level can be precisely detected with the fluid level detecting unit regardless of a traversal movement of the sub-tank.

Furthermore, it is preferable that a filter be arranged in a portion on the ink storage chamber side that connects with the ink supply path. With this configuration, even if the liquid ink mixed with foreign particles such as dirt is supplied from the main tank, these particles are removed using a component that fits in an opening towards the ink reservoir chamber. Thus, the liquid ink inside the ink reservoir chamber and supplied to the printer head is free of any contaminants. As a result, the liquid ink can be discharged from the printer head without causing a discharge failure.

Obviously, numerous modifications and variations of the present invention are possible in light of the above teachings. It is therefore to be understood that within the scope of the appended claims, the invention may be practiced otherwise than as specifically described herein.

1. An ink supply apparatus comprising:
a sub tank connected to a printer head and having an ink reservoir chamber formed in the sub tank to store a liquid ink, the printer head being capable of discharging the liquid ink which is supplied from the ink supply apparatus;
a fluid level detector provided inside the ink reservoir chamber and configured to detect a fluid level of the liquid ink stored in the ink reservoir chamber, the fluid level detector comprising:
a casing having a section through which a light is to pass and which has an outer surface that is to contact the liquid ink according to an amount of the liquid ink stored in the ink reservoir chamber;
a light emitting device arranged inside the casing and capable of emitting the light toward the outer surface through the section; and
a light receiving device to receive reflected light reflected at the outer surface when the outer surface does not contact the liquid ink and reflects the light emitted from the light emitting device;
an ink supply path connecting a main tank and the ink reservoir chamber to supply the liquid ink from the main tank to the ink reservoir chamber;
an internal pressure regulating path connecting the ink reservoir chamber and a pressure regulating device capable of sucking air from or discharging air to the ink reservoir chamber so as to regulate an internal pressure of the ink reservoir chamber; and
a storage amount determining device configured to determine whether a predetermined amount of the liquid ink is stored in the ink reservoir chamber based on detection results of the fluid level detector.

2. The ink supply apparatus according to claim 1,
wherein the fluid level detector is configured such that, when the liquid ink stored in the ink reservoir chamber does not contact the outer surface of the section, the light emitted from the light emitting device is reflected at the outer surface based on a refractive index difference between the section and the air, and the reflected light with a intensity higher than a predetermined intensity is received by the light receiving device, and
wherein the fluid level detector is configured such that, when the liquid ink stored in the ink reservoir chamber contacts the outer surface of the section, the light emitted from the light emitting device transmits into the liquid ink through the outer surface based on a refractive index difference between the section and the liquid ink, and the light receiving device receives a light having a lower intensity than the predetermined intensity.

3. The ink supply apparatus according to claim 1, further comprising:
a pressure feed device provided in the ink supply path and capable of feeding the liquid ink from the main tank to the ink reservoir chamber,
wherein the storage amount determining device is configured to control, when determining an amount of the liquid ink stored in the ink reservoir chamber is less than the predetermined amount, the pressure feed device to supply the liquid ink from the main tank to the ink reservoir chamber.

4. The ink supply apparatus according to claim 1,
wherein the sub-tank has ribs formed in the sub tank to protrude from a side of the sub-tank to the ink reservoir chamber, the ribs being arranged on both sides of the fluid level detecting device.

5. The ink supply apparatus according to claim 1,
wherein the sub-tank includes a filter member arranged in a portion of the ink reservoir chamber connecting to the ink supply path.

6. The ink supply apparatus according to claim 2, further comprising:
a pressure feed device provided in the ink supply path and capable of feeding the liquid ink from the main tank to the ink reservoir chamber,
wherein the storage amount determining device is configured to control, when determining an amount of the liquid ink stored in the ink reservoir chamber is less than the predetermined amount, the pressure feed device to supply the liquid ink from the main tank to the ink reservoir chamber.

7. The ink supply apparatus according to claim 2,
wherein the sub-tank has ribs formed in the sub tank to protrude from a side of the sub-tank to the ink reservoir chamber, the ribs being arranged on both sides of the fluid level detecting device.

8. The ink supply apparatus according to claim 3,
wherein the sub-tank has ribs formed in the sub tank to protrude from a side of the sub-tank to the ink reservoir chamber, the ribs being arranged on both sides of the fluid level detecting device.

9. The ink supply apparatus according to claim 6,
wherein the sub-tank has ribs formed in the sub tank to protrude from a side of the sub-tank to the ink reservoir chamber, the ribs being arranged on both sides of the fluid level detecting device.

10. The ink supply apparatus according to claim 2,
wherein the sub-tank includes a filter member arranged in a portion of the ink reservoir chamber connecting to the ink supply path.

11. The ink supply apparatus according to claim 3,
wherein the sub-tank includes a filter member arranged in a portion of the ink reservoir chamber connecting to the ink supply path.

12. The ink supply apparatus according to claim 4,
wherein the sub-tank includes a filter member arranged in a portion of the ink reservoir chamber connecting to the ink supply path.

13. The ink supply apparatus according to claim 6,
wherein the sub-tank includes a filter member arranged in a portion of the ink reservoir chamber connecting to the ink supply path.

14. The ink supply apparatus according to claim 7,
wherein the sub-tank includes a filter member arranged in a portion of the ink reservoir chamber connecting to the ink supply path.

15. The ink supply apparatus according to claim 8,
wherein the sub-tank includes a filter member arranged in a portion of the ink reservoir chamber connecting to the ink supply path.

16. The ink supply apparatus according to claim 9,
wherein the sub-tank includes a filter member arranged in a portion of the ink reservoir chamber connecting to the ink supply path.
